(19) United States
(12) Patent Application Publication
(10) Pub. No.: US 2010/0146078 A1
(43) Pub. Date: Jun. 10, 2010

(54) SYSTEM AND METHOD FOR CONTROLLING PRESENTATION OF MULTIMEDIA CONTENT

(76) Inventors: Mark S. Wolff, Ottawa (CA); Stephen Craig Bews, Ottawa (CA); James Ghadbane, Ottawa (CA)

Correspondence Address: Mark S. Wolff, 24 Marchvale Drive, Ottawa, K2W 1C2, CA

(21) Appl. No.: 12/476,614

(22) Filed: Jun. 2, 2009

Related U.S. Application Data
(60) Provisional application No. 61/058,127, filed on Jun. 2, 2008.
(60) Provisional application No. 61/165,573, filed on Apr. 1, 2009.

(51) Int. Cl. G06F 3/01; G06F 15/16

(52) U.S. Cl. 709/219; 715/730

(57) ABSTRACT

A system and a method for controlling the presentation of multimedia content. Multimedia content is provided to a plurality of multimedia devices, control signaling is sent to each of the plurality of multimedia devices, and responsive to the control signaling, each of the multimedia devices presents the provided multimedia content. The multimedia content provided to each multimedia device can alternatively be the same or coordinated (i.e. different) content. The control signaling can include indications as to which of the multimedia content to present, when to start presenting it, and when to stop presenting it. Responsive to the control signaling, each of multimedia devices can present one or more items of multimedia content. The coordinated presentation of multimedia content by the plurality of multimedia devices results in a collective form of multimedia presentation that goes beyond the presentation of the individual multimedia content items on each of the individual multimedia devices.

### CROSS-REFERENCE TO RELATED APPLICATIONS

This application claims priority from U.S. Provisional Patent Application Ser. Nos. 61/058,127 and 61/165,573, filed Jun. 2, 2008 and Apr. 1, 2009 respectively, the entirety of each of which is incorporated herein by reference.

### FIELD OF INVENTION

The present invention relates to the field of multimedia presentation systems. In particular, to a system and a method for controlling the presentation of multimedia content.

### BACKGROUND

A wide assortment of multimedia devices, both mobile and fixed, wireless and wired, allow an almost infinite combination of multimedia content to be presented to people. Multimedia is generally described as a technique for expressing ideas using some combination of text, colors, still pictures or video, and audio. While instances of synchronized multimedia content displays have existed for some time, the best example being broadcast television, the plethora of new multimedia devices such as cellular phones, iPods® and personal computers, and the arrival of sophisticated communication networks, for example Ethernet for wired devices, Bluetooth®, Wi-Fi and cellular phone networks for wireless devices, has allowed for multimedia to be viewed in a variety of locations, in a variety of formats and on a variety of devices.

While a number of situations or applications where multimedia is viewed on multimedia devices does not require or is not enhanced by having the multimedia presented concurrently, nearly concurrently, or in sequence on all or some devices, there are situations where coordination would be of benefit. One example would be at music concerts, sporting events, theatre presentations and other gatherings where video screens and lighting systems are currently used to present multimedia. Another example would be lectures, where instead of multimedia information such as a slideshow presentation or video being presented to attendees via a central display screen, participants could view the multimedia content individually on a variety of multimedia devices.

There remains a general need in the art for a system and method for simultaneous or near simultaneous control of a presentation of multimedia content on a variety and variable number of multimedia devices.

### SUMMARY OF INVENTION

A system and a method for controlling the presentation of multimedia content. The present invention addresses the need for a system and method for simultaneous or near simultaneous presentation of multimedia content on a variety and variable number of multimedia devices. Multimedia devices are devices capable of presenting (e.g. displaying) combinations of text, still images, color, animation, video, and audio content. Multimedia devices can include, for example, cellular (a.k.a. mobile) phones, digital media players (e.g. iPods®), personal digital assistants (PDA), laptop and personal computers.

In one aspect of the present invention, multimedia content is provided to a plurality of multimedia devices, control signaling is sent to each of the plurality of multimedia devices, and responsive to the control signaling, each of the multimedia devices presents the provided multimedia content. The multimedia content provided to each multimedia device can alternatively be the same or coordinated (i.e. different) content. The control signaling can include indications as to which of the multimedia content to present, when to start presenting it, and when to stop presenting it. Responsive to the control signaling, each of multimedia devices can present one or more items of multimedia content. The coordinated presentation of multimedia content by the plurality of multimedia devices results in a collective form of multimedia presentation that goes beyond the presentation of the individual multimedia content items on each of the individual multimedia devices. This is exemplified when the present invention is used to arrange for the presentation of visual media on the displays of mobile phones belonging to a plurality of users gathered at an event such as, for example, a music concert or sporting event and wherein each user holds his mobile phone such that the display can be seen by many of the other users effectively transforming the collective of all of the mobile phone displays into a single multimedia display.

The present invention uses a computing platform to signal to the multimedia devices which multimedia content they are to display, when to start displaying it, and when to stop displaying it. The multimedia devices can in turn forward this signaling on to other multimedia devices. Signaling is achieved using one or more communications networks, which allows a variety and variable number of multimedia devices to be included, and the multimedia devices can be at the same or at different physical locations.

In another aspect of the present invention a lighting or video control console, lightboard, lighting board, light desk, video console or similar system (e.g. a Wholehog® console system) can be used to signal a trigger, via a control protocol such as DMX-512 or ACN, to a computing platform indicating which multimedia content the multimedia devices are to present, when to start presenting it, and when to stop presenting it.

A trigger for the signaling to occur from the computing platform can be created from the lighting control console, or alternatively from a user input interface such as a keyboard which is connected to the computing platform, or can be remotely invoked over a communication network from a distant user input interface. The user input interface can be a multimedia device. A trigger can be entered for each multimedia presentation change, start or stop command, or alternatively a trigger can start an automated sequence of signals sent from the computing platform to the multimedia devices over time. Further, the signals themselves contain time information for multimedia display change, start or stop commands, and the multimedia devices themselves can implement the signaled commands with respect to time. The signaling is used to synchronize identical or coordinated multimedia displays on the signaled multimedia devices.

The signaling from the computing platform to the multimedia devices, and thus the multimedia displayed by one or more multimedia devices, can be altered by feedback signaling from each of the multimedia devices to the computing platform. A user of a multimedia device can input data into the multimedia device that is transferred through signaling to the computing platform, influencing what multimedia content is displayed on one or more multimedia devices. For example, the user can enter data to signal to the computing platform not to display multimedia on the user's multimedia device, or signal to the computing platform that the user is part of a group of devices that will be provided the same multimedia content.

The multimedia content and the control signaling to a multimedia device can be different for each multimedia device, allowing each device, or each group of devices, to display the same or different multimedia content. The signaling or alternatively the reaction to the signaling can be a function of a physical location of each of the multimedia devices. For example, multimedia devices within the same area of a room can all get the same signaling but those devices in another location can get alternative signaling and present a different multimedia content. The location of the multimedia device can be derived by the device itself using well know location detection mechanisms such as, for example, Global Positioning System (GPS), or the location can be entered into the device by the user, for example a seat number in an arena.

The multimedia content can be provided to the multimedia device or devices in advance through download of the multimedia content to the multimedia devices over a communication network, or alternatively through real-time delivery of the multimedia content to the multimedia devices over a communication network.

The multimedia devices, and the computing platform both synchronize their local time, or determine their local time offset, using a well known timing synchronization protocol such as, for example, Internet Engineering Task Force (IETF) Network Working Group (NWG) Request for Comment (RFC) 1305 Network Time Protocol (NTP). Alternatively the multimedia devices synchronize their local time, or determine their local time offset, with that of the computing platform using a timing synchronization protocol such as Network Time Protocol (NTP).

In an alternative embodiment, the present invention can comprise a plurality of lighting or video control consoles, and further comprise a plurality of computing platforms, that all can be connected over a communication network. An advantage of using a plurality of lighting or video control consoles for signaling to the computing platforms is signaling redundancy in case of a lighting or video control console, a computing platform or a network failure. Advantages of using a plurality of computing platforms for signaling to the multimedia devices include supporting larger numbers of multimedia devices by partitioning (i.e. distributing) multimedia device control amongst the computing platforms, providing different signaling methods for differing groups of multimedia devices, and signaling redundancy in the case of computing platform or network failures.

In accordance with one aspect of the present invention, there is provided a method for controlling the presentation of multimedia content on a plurality of multimedia devices comprising the steps of: establishing a list of the plurality of multimedia devices; providing each of the multimedia devices with one or more items of multimedia content; responsive to receiving a trigger message, creating and sending, to one or more of the multimedia devices on the list, a multimedia control message (MMCM); responsive to fields contained in the MMCM, each multimedia device initiating an action including one of: starting presentation, stopping presentation, and presenting a next item of multimedia content; and repeating, for subsequently received trigger messages, the steps of creating and sending a MMCM, and of initiating an action; wherein the presentation of multimedia items on the plurality of multimedia devices creates a form of multimedia presentation unto itself.

In accordance with another aspect of the present invention, there is provided a system for controlling the presentation of multimedia content on a plurality of multimedia devices comprising: a computing platform for: establishing a list of the plurality of multimedia devices; responsive to receiving a trigger message, creating a multimedia control message (MMCM); and creating further MMCM for each subsequently received trigger message; a signaling module for sending the MMCM to one or more of the multimedia devices on the list; and a plurality of coordination modules, each associated with one of the multimedia devices, for: making available to the multimedia device one or more items of multimedia content; and responsive to fields contained in the MMCM, causing the multimedia device to initiate an action including one of: starting presentation, stopping presentation, and presenting a next item of multimedia content; and causing the multimedia device to initiate a further action for each subsequently received MMCM; wherein the presentation of multimedia items on the plurality of multimedia devices creates a form of multimedia presentation unto itself.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIG. 1 is a schematic representation of an exemplary embodiment of a system for controlling presentation of multimedia content in an exemplary operating environment.

FIG. 2 is a schematic representation of exemplary paths that can be taken to signal commands to multimedia devices.

FIG. 3 is a schematic representation of a multimedia device forwarding signaling to other multimedia devices.

FIG. 4 is a schematic representation of an exemplary MMCM format and three examples of MMCM content.

FIG. 5 is a schematic representation of exemplary trigger signaling.

FIG. 6 is a schematic representation of exemplary trigger signaling originating on a multimedia device.

FIG. 7 is schematic representation of an exemplary trigger message format and two examples of trigger message content.

FIG. 8 is a flow diagram of exemplary steps for managing the presentation of multimedia information on a multimedia device.

FIG. 9 is a flow diagram of exemplary steps for creating a trigger response to user input at a user input interface.

FIG. 10 is a flow diagram of exemplary steps for sending signaling from a computing platform.

FIG. 11 is a schematic representation of multimedia content being downloaded.

FIG. 12 is a schematic representation of signaling from a lighting control platform to a computing platform.

FIG. 13 is a schematic representation of time synchronization.

FIG. 14 is a schematic representation of an alternative method of time synchronization.

FIG. 15 is a flow diagram of steps for sending signaling from a computing platform responsive to input from a lighting control platform.

FIG. 16 is a schematic representation of an exemplary collective multimedia presentation in accordance with the present invention.

### DETAILED DESCRIPTION

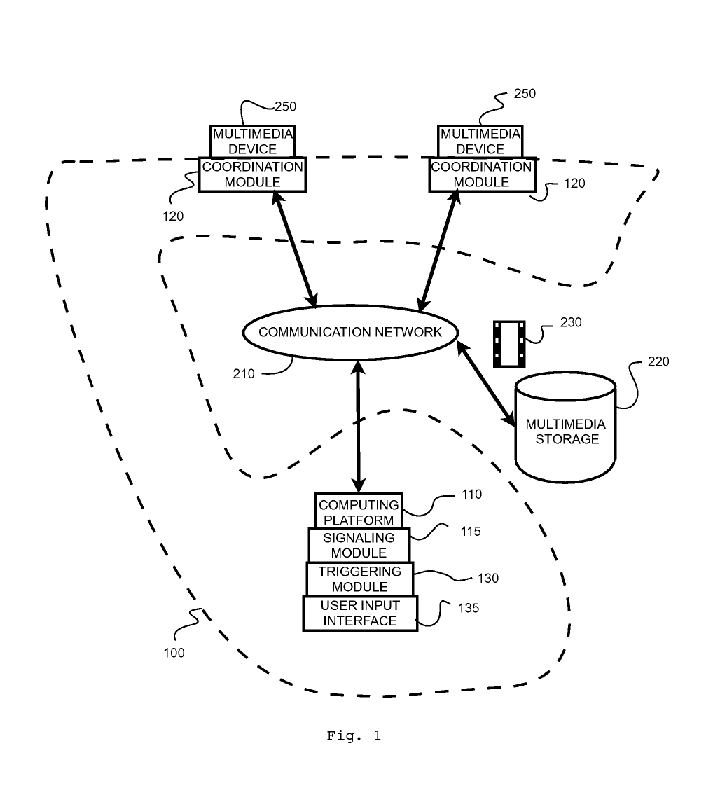

FIG. 1 is a schematic representation of an exemplary embodiment of a system for controlling presentation of multimedia content in an exemplary operating environment. The system 100 provides for controlling the presentation of multimedia content on a plurality of multimedia devices 250. The system 100 comprises a computing platform 110, a signaling module 115, a plurality of coordination modules 120, a triggering module 130, and a user input interface 135. An instance of the coordination module 120 resides on each of the multimedia devices 250. The signaling module 115 can be co-located with the computing platform 110.

The system 100 provides for multimedia content to be presented on one or more of the multimedia devices 250 in a time coordinated fashion so that the collective presentation of the multimedia content across the plurality of multimedia devices 250 becomes a form of multimedia presentation onto itself The multimedia devices 250 are well-known devices capable of presenting (e.g. displaying or playing) combinations of text, still images, color, animation, video, and audio content. The multimedia devices 250 can include, for example, cellular (a.k.a. mobile) phones, digital media players (e.g. iPods®), personal digital assistants (PDA), laptop and personal computers.

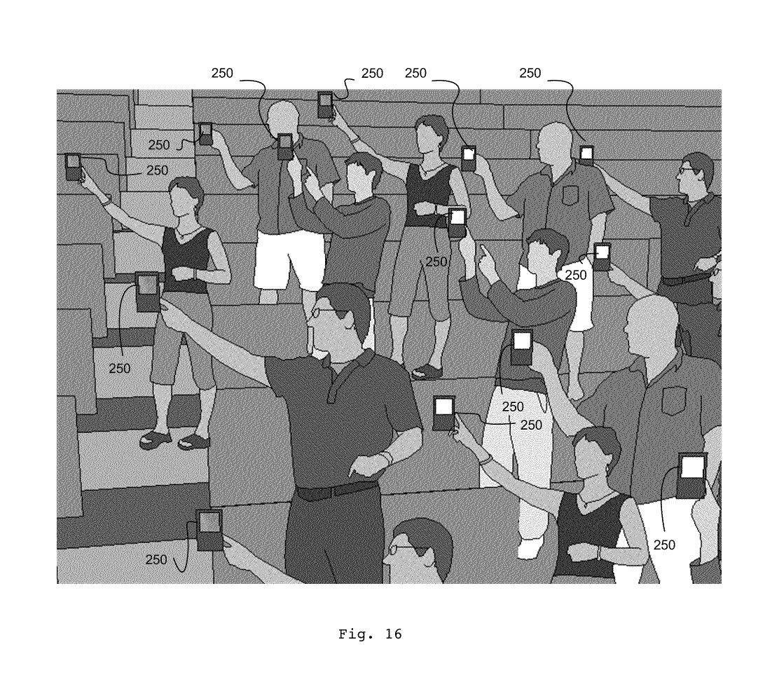

FIG. 16 is a schematic representation of an exemplary collective multimedia presentation in accordance with the present invention. In this example a plurality of users attending a venue (e.g. a concert or a sporting event) are each holding aloft a multimedia device 250. Each of the multimedia devices 250 is assigned to one of two groups. The multimedia devices 250 in the first group, generally in the left half of the illustration, display (i.e. present) a first item of multimedia content, while the multimedia devices 250 in the second group, generally in the right half of the illustration, display a different second item of multimedia content, The represented example is simplified for illustrative purposes. It will be understood that with the use a larger number of multimedia devices 250 that more complex presentations can be achieved with the present invention including, for example, the pixilated display of a national flag or a team logo.

Referring again to FIG. 1, each multimedia device 250 can become know to the system 100 by any of a variety of well known registration mechanisms. Registration of a multimedia device 250 can be based on a mechanism provided by a communications protocol (e.g. GSM, Wi-Fi, Bluetooth) supported by the multimedia device 250. In the case of Bluetooth for example, the computing platform 110 can broadcast, via the signaling module 115, a Universally Unique Identifier (UUID) and a service name as being available. Multimedia devices 250 within Bluetooth range can perform an enquiry on the UUID and service name and then connect to the computing platform 110 via the signaling module 115. The computing platform 110 maintains a list of multimedia devices 250 that are known to it (i.e. detected or registered). One or more known multimedia devices 250 can be combined to form a group (not illustrated). The computing platform 110 can broadcast more than one combination of UUID and service name to provide for separate signaling to each of a plurality of multimedia device 250 groups.

The list of multimedia devices 250 that the computing platform 110 signals to can be created in real-time. In an exemplary embodiment each multimedia device 250 registers with the computing platform 110 by sending an SMS or email message containing the address of that multimedia device 250, such as the device's Internet Protocol (IP) address, or telephone number, as well as it's physical location (e.g. a seat number in a room) when applicable, to the computing platform's 110 address (e.g. IP address or telephone number). The computing platform 110 builds the list of multimedia devices 250 and associated addresses to send signaling to. The list can be sorted by an operator into a plurality of separate lists (i.e. groups) to allow different media content 230 to be shown on different multimedia devices 250. Also the user can enter data into the multimedia device 250 that is then sent to the computing platform 110, and based on this data separate lists are created to allow different media content 230 to be shown on different multimedia devices 250. In an exemplary embodiment, inclusion of each multimedia device 250 in a particular one of a plurality of lists can be based on the physical location of the multimedia device 250.

Real-time multimedia device list creation can be used when it is not known in advance whether a multimedia device 250 will be included. Attendees to a concert can register their multimedia devices 250 when they first arrive at the concert, or can register remotely from another physical location.

The list of multimedia devices 250 can be manually or automatically created from an external list of multimedia devices 250. In an exemplary embodiment, the address of each multimedia device 250 is recorded when that device 250 downloads multimedia content 230 from a multimedia storage repository 220.

The computing platform 110 comprises well-known hardware and software components typically found in workstations and personal computers. The computing platform 110 can support one or more well-known communication protocols such as, for example, Ethernet, Transmission Control Part/Internet Protocol (TCP/IP), GSM, Short Message Service (SMS), Wi-Fi, and Bluetooth. The computing platform 110 can communicate with each of the multimedia devices 250 using any mutually supported protocol via a corresponding communication network 210 (e.g. GSM, Internet) or alternatively directly on a peer-to-peer basis. The computing platform 110 can optionally further comprise support for one or more well-know protocols such as, for example, Ethernet, USITT DMX 512-A, or EIA-485 for signaling with a lighting control panel.

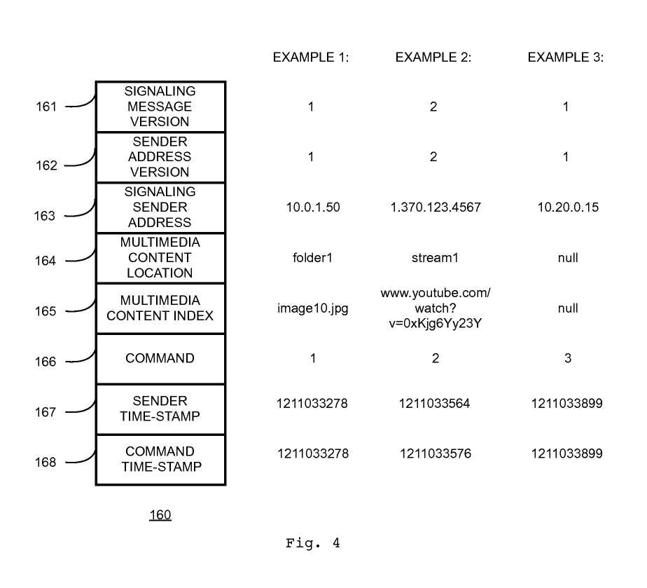

The computing platform 110 can determine for each multimedia device 250 or group of devices 250 what multimedia content the devices 250 are to be presented. The computing platform 110, in conjunction with the signaling module 115, sends signals in the form of a multimedia control messages (MMCM) to each multimedia device 250. FIG. 4 is a schematic representation of an exemplary MMCM 160 format and three examples of MMCM 160 content. The MMCM 160 contains data fields including, for example: a signaling message version 161, a sender address version 162, a signaling sender address 163, a multimedia content location 164, a multimedia content indexn 165, a command 166, a sender time-stamp 167, and a command time-stamp 168. The signaling message version 161 is used to indicate downloaded multimedia content (e.g. signaling message version=1) or streamed multimedia content (e.g. signaling message version =2). The signaling sender address 163 provides a source address of the MMCM 160 sender in case verification of the sender or a response is required. The sender address version 162 indicates a type of sender address (e.g. 1 indicates IP, and 2 indicates an 11-digit telephone number). The multimedia content location 164 identifies a location where the multimedia content is provided (e.g. a folder name, in a file system, in the case of downloaded multimedia content, and a stream group name in the case of streamed multimedia content). The multimedia content index 165 identifies the particular item of multimedia content at the location identified by the multimedia content location field 164 (a filename in the case of downloaded multimedia content, and a stream descriptor in the case of streamed multimedia content). The command 166 identifies an action to be taken by the multimedia device 250 (e.g. a value of 1 indicates start multimedia content presentation, a value of 2 indicates stop multimedia content presentation, a value of 3 indicates synchronize timing). The sender time-stamp 167 contains a time-stamp according to Coordinated Universal Time (UTC) of the time at the signaling module 115 when the MMCM was sent. The commend time-stamp 168 contains a time in accordance with UTC at which the multimedia device 250 is to execute the command indicated in the commend field 166.

An MMCM 160 that indicates a synchronize-timing command (a.k.a. a timing sync message) directs the multimedia device 250 to synchronize to the time-stamp in the sender time-stamp field 167. Timing sync messages are sent periodically by the signaling module 115 to provide the multimedia devices 250 a reference for coordinating their UTC time with that of the computing platform 110. In an alternative embodiment, described below, any of a number of well-know mechanisms for timing synchronization can be used.

The determined multimedia content 230 is provided to each multimedia device 250 by multimedia storage device 220 via the communication network 210. The multimedia content can be download by the multimedia device 250 in advance of a presentation of the multimedia content 230, or alternatively where the available bandwidth in a communications network 210 is sufficient, the multimedia content 230 can be streamed to the multimedia device 250 in real-time during the presentation of the multimedia content 230.

The triggering module 130 provides for triggering manual or automated (i.e. sequential) signaling to the multimedia devices 250 from the user input interface 135, a lighting console, another computing platform 110, or a multimedia device 250. Using a communication network 210 over which to trigger the signaling permits the computing platform 110 performing the signaling to be proximate the multimedia presentation area (i.e. the venue), or alternatively the computing platform 110 may be elsewhere.

The user input interface 135 provides for a human operator to enter (i.e. input) an indication that they wish to initiate triggering of multimedia content presentation on the one or more multimedia devices 250. The operator can indicate that he wants to initiate a single presentation of multimedia content 230 or alternatively that he wishes to initiate an automatic sequential presentation of a plurality of multimedia content 230. The operator-entered indication is sent to the triggering module 130 to initiate triggering of a presentation.

The coordination module 120 receives signals in the form of MMCM containing indications (i.e. commands) to change, start or stop presentation of multimedia content. The coordination module 120 interacts with the associated multimedia device 250 to carry out the command in the MMCM with regard to presentation of the multimedia content. The MMCM can further contain time information indicating when to enact the command, and the coordination module 120 implements, in cooperation with the multimedia device 250, the command contained in the MMCM at the indicated time. A plurality of coordination modules 120, each one associated with one from a plurality of multimedia devices 250, are used to synchronize identical or coordinated multimedia presentations on the plurality of multimedia devices 250.

The coordination module 120 on (i.e. associated with) each multimedia device 250 can forward the signaling it receives on to other multimedia devices 250 to allow more types of multimedia devices 250 to participate in the multimedia presentation. For example, concert participants may not all have the same multimedia device 250 communication network capabilities, or may not all be on the same communication network 210. For example, some devices have only Bluetooth® as a communication network 210 capability or may not be on the same communication network 210 as the signaling computing platform 110. By using Bluetooth® between multimedia devices 250, the signaling received by one multimedia device 250 on one communication network 210 is forwarded to other multimedia devices 250, not on the same communication network 210, to achieve the coordinated presentation (e.g. display) of multimedia content 230.

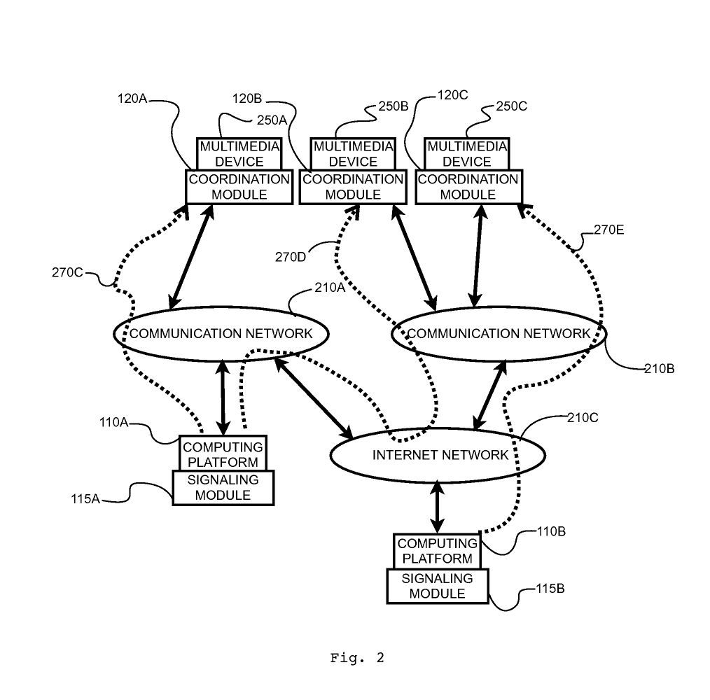

In FIGS. 2-3, 5-6, and 11 of this document, for ease of reference to multiple instances of elements of the same type, reference numerals comprising a numeric component followed by a letter (e.g. 250D, 210A) are used to designate distinguishable instances, each having a unique letter (e.g. A, C), of elements of the same type represented by the numeric component (e.g. 250=multimedia device). For example, 250A and 250B are two distinguishable, but otherwise equivalent, instances of a multimedia device 250.

In FIGS. 2-3, 5-6, and 11 of this document, solid lines between elements represent connections that support data communications (e.g. a MMCM signal, a trigger or multimedia content 230 download), and dotted lines illustrate a path taken by a data communication using corresponding connections.

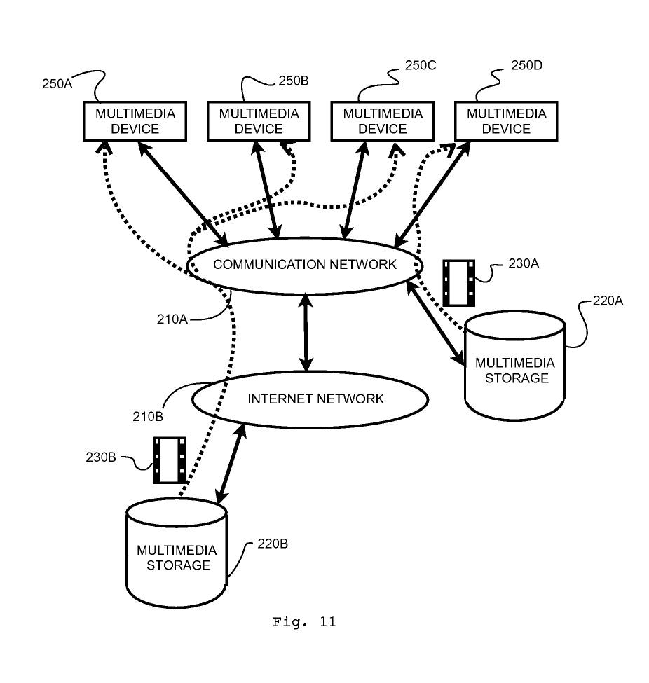

FIG. 11 is a schematic representation of multimedia content being downloaded. The system 100 is not illustrated for clarity. After receiving a MMCM each of multimedia devices 250A-D can download one or more items of multimedia content 230A,B. In the exemplary scenario illustrated, multimedia device 250D downloads multimedia content 230A from multimedia storage 220A via communication network 210A. Each of multimedia devices 250A-C downloads multimedia content 230B from multimedia storage 220B via an Internet network 210B and the communications network 210A. The present invention can be used in conjunction with any number of multimedia storage repositories 220 each one connected to one or more multimedia devices 250 via one or more communication networks 210. In an alternative embodiment, when the multimedia content 230 is downloaded in advance, it can be bundled with a coordination module 120 on the multimedia devices 250.

The download of the multimedia content 230 can use well-known mechanisms such as, for example, File Transfer Protocol (FTP), or Wireless Application Protocol (WAP). The multimedia content 230 alternatively can be streamed to the multimedia devices 250 using well-known mechanisms such as, for example, Real-time Streaming Protocol (RTSP). The multimedia content 230 can be downloaded as separate files, as one file, or can be contained within modules (e.g. coordination module 120) on the multimedia devices 250. When streamed the multimedia content 230 can be contained in separate streams, or streamed as one item.

Conditions for using streaming of multimedia content 230 include when the content 230 is provided by a remote supplier such as video sharing web site, when the multimedia content 230 is too large to be stored on the multimedia devices 250 in advance of presentation, and when the multimedia content changes often thereby making it difficult to ensure that all the multimedia devices 250 have downloaded the same multimedia content 230 at the time of the presentation.

Conditions for using downloading of multimedia content 230 include when the communication network 210 will not support the bandwidth required to stream the multimedia content 230 to the multimedia devices 250, and when the multimedia content 230 is static and displayed often such that downloading once is more efficient than streaming many times.

FIG. 2 is a schematic representation of exemplary paths that can be taken to signal commands to multimedia devices 250. In the illustrated example, computing platform 110A, in conjunction with signaling module 115A, signals a MMCM to multimedia device 250A via communications network 210A along path 270C and further signals a MMCM to multimedia device 250B via communications networks 210A-B and Internet network 210C along path 270D. Computing platform 110B, in conjunction with signaling module 115B, signals a MMCM to multimedia device 250C via Internet network 210C and communications network 210B along path 270E.

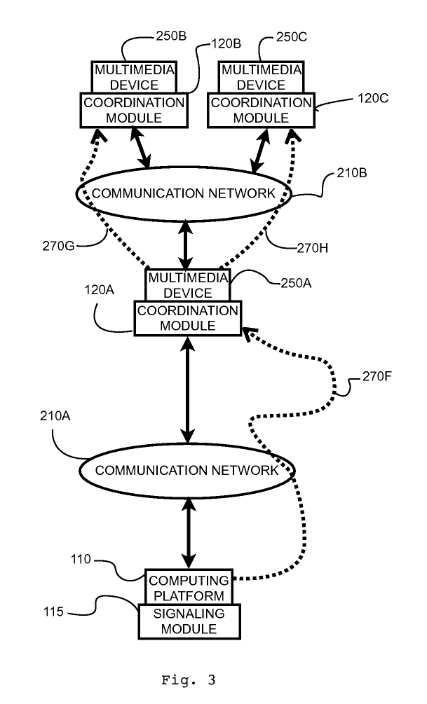

FIG. 3 is a schematic representation of a multimedia device 250A forwarding signaling to other multimedia devices 250B-C. In the illustrated example, computing platform 110, in conjunction with signaling module 115, signals a MMCM to multimedia device 250A via communications network 210A along path 270F. Multimedia devices 250B-C are not connected to communications network 210A and therefore can not receive signaling directly from computing platform 110. However, all of multimedia devices 250A-C are connected to communications network 210B. Multimedia device 250A forwards the MMCM received from the computing platform 110 via communications network 210B to multimedia device 250B along path 270G, and to multimedia device 250C along path 270H.

Forwarding of signaling by multimedia devices 250 can be used to ensure that signaling is received by another multimedia device 250. In the case where a signaling message (e.g. MMCM), for example sent as an SMS message, is lost a multimedia device 250 forwarding a second instance of the signaling message to a neighboring multimedia device 250 can replace the lost signaling message. The coordination module 120 associated with multimedia devices 250 can ignore duplicate signaling messages, or process duplicate signaling messages such that only one result of the signaling is performed. For example, receiving duplicate signaling messages to start a multimedia presentation at time X will only result in the multimedia presentation starting at time X once.

The list of multimedia devices 250 that a multimedia device 250 is to forward signaling to can be populated as described above with reference to the computing platform 110 and FIG. 1. The multimedia devices 250 connected to the same communication network 210B as the computing platform 110 are responsible for registering on behalf of multimedia devices 250A-B that do not have direct access to the computing platform 110.

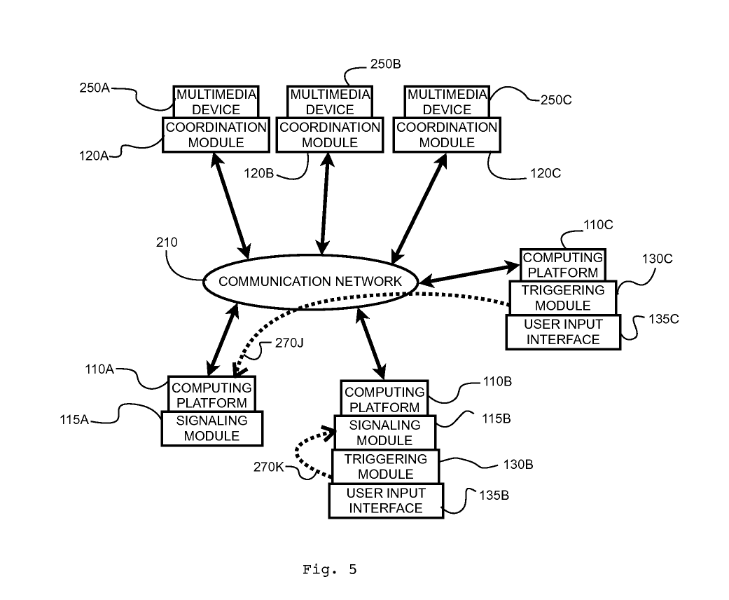

FIG. 5 is a schematic representation of exemplary trigger signaling. In the illustrated example, triggering module 130C, associated with computing platform 110C and user input interface 135C, can send a trigger message to signaling module 115A and associated computing platform 110A via communications network 210 along path 270J. Triggering module 130B can signal a trigger to associated signaling module 115B and computing platform 110B as indicated by path 270K without the need for a communications network 210.

In an alternative embodiment (not illustrated), the user input interface 135 does not need to be associated with a computing platform 110. The user input interface 130 can be a radio signal or infrared transmitter-receiver pair, similar to those used as remote controls for televisions, garage doors and other consumer electronics.

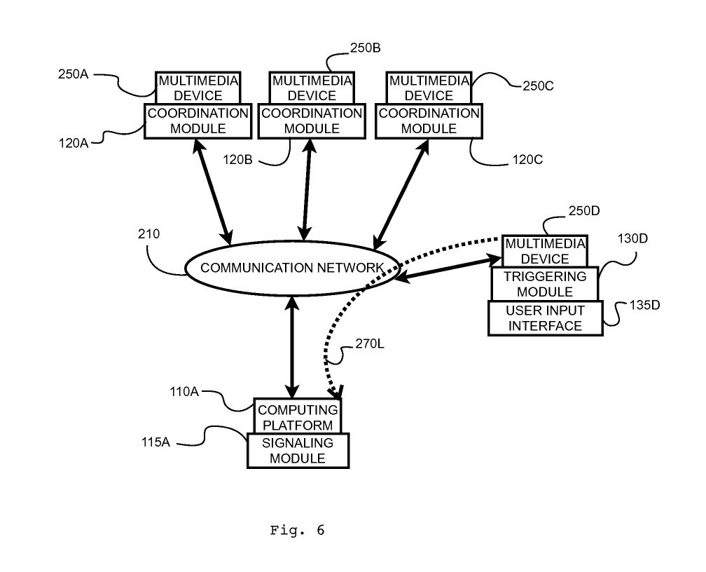

FIG. 6 is a schematic representation of exemplary trigger signaling originating on a multimedia device 250D. In the illustrated example, triggering module 130D, associated with multimedia device 250D and user input interface 135D, can send a trigger message to signaling module 115 and associated computing platform 110 via the communication network 210 along path 270L. Responsive to the trigger message being received, the computing platform 110 can signal the message to each of multimedia device 250A-D via communications network 210.

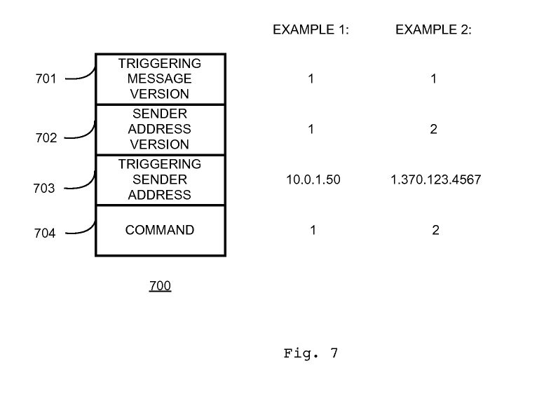

FIG. 7 is a schematic representation of an exemplary trigger message 700 format and two examples of trigger message 700 content. The trigger message 700 contains data fields including, for example: a triggering message version 701, a sender address version 702, a triggering sender address 703, and a command 704. The triggering message version 701 provides for more than one format to used for trigger messages 700. The triggering sender address 703 provides the source address of an originating triggering module 130 in the case a verification of the sender or a response is required. The sender address version 702 indicates a type of the data in the triggering sender address 703 field (e.g. 1 indicates IP, and 2 indicates an 11-digit telephone number). The command 704 indicates the action to be taken (e.g. 1=switch to next multimedia content location; 2=switch of next multimedia index; 3=start multimedia presentation; 4=start multimedia presentation sequence; and 5=stop multimedia presentation).

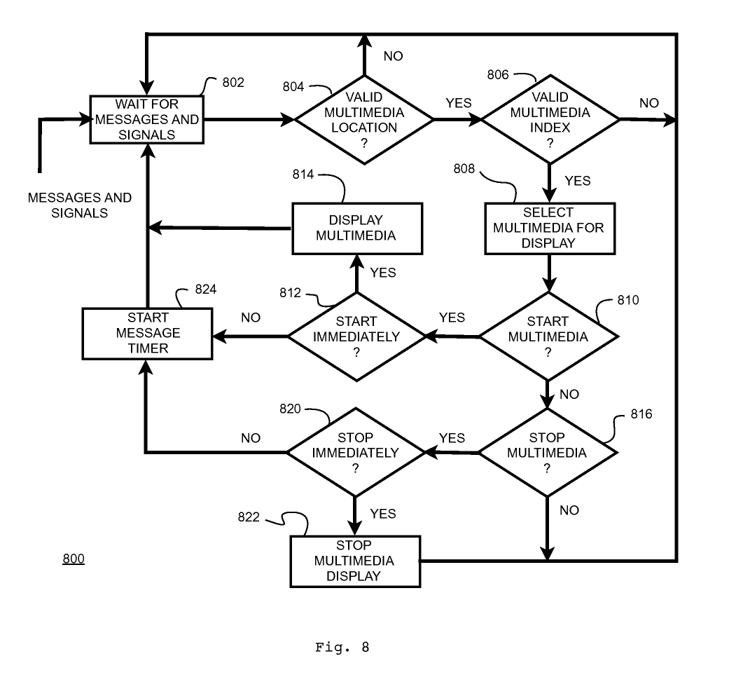

FIG. 8 is a flow diagram of exemplary steps 800 for managing the presentation of multimedia information on a multimedia device 250. The steps 800 can be implemented, for example, in a coordination module 120 associated with the multimedia device 250. In step 802 the multimedia device 250 waits for the receipt of an internal message, such as a timer expiry message, or of an external signal. Upon receipt of a message or signal, in step 804, the validity of a multimedia location where the multimedia content is to be found is verified. When the multimedia location is not valid, execution returns to step 802. When the multimedia location is valid, in step 806, the validity of a multimedia index, that indicates which element of multimedia content is to be presented, is verified. When the multimedia index is not valid execution returns to step 802. When the multimedia index is valid, in step 808, the multimedia content is retrieved (e.g. downloaded) and prepared for presentation. In step 810 a determination is made whether to start presentation of the multimedia content. When it is determined that presentation of the multimedia content is to be started, in step 812, a determination is made whether to start presentation immediately. When it is determined that presentation of is to start immediately, in step 814 the multimedia content is presented (e.g. displayed). When it is determined that the content is not to be presented immediately (i.e. is to be presented at a later time), in step 824 a system message is created and a delay timer is started. The system message contains the validated multimedia location, multimedia index and a start commend, and is received at step 802 after expiry of the delay timer. When it is determined that presentation of the multimedia content is not to be started, in step 816, a determination is made whether to stop presentation of the multimedia content. When it is determined that presentation of the multimedia content is to be stopped, in step 820, a determination is made whether to stop presentation immediately. When it is determined that presentation of is to stop immediately, in step 822 the presentation (e.g. display) of the multimedia content is stopped. When it is determined that presentation of the content is not to be stopped immediately (i.e. presentation is to be stopped at a later time), in step 824 a system message is created and a delay timer is started. The system message contains the validated multimedia location, multimedia index and a stop commend, and is received at step 802 after expiry of the delay timer.

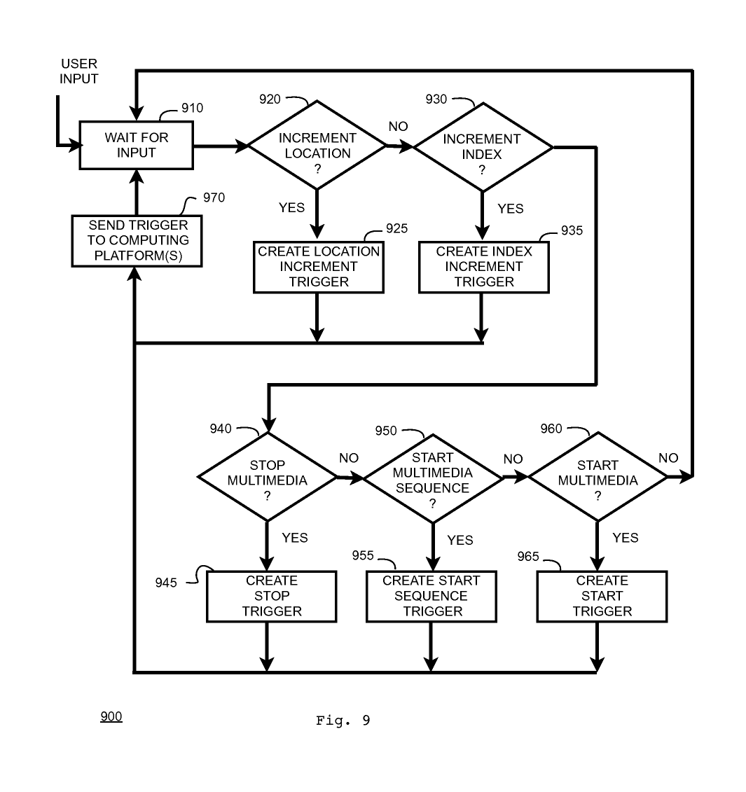

FIG. 9 is a flow diagram of exemplary steps 900 for creating a trigger response to user input at a user input interface 135. The steps 900 can be implemented, for example, in a triggering module in conjunction with the user input interface 135. In step 910 a user input from the user input interface 135 is awaited. When an input is receive, in step 920 a determination is made as to the input signifying to increment the multimedia location. When the input does signify that the multimedia location is to be incremented, in step 925 a trigger comprising a ‘next multimedia location’ command is created and in step 970 the created trigger is sent to a computing platform 110. When the input does not signify that the multimedia location is to be incremented, in step 930 a determination is made as to the input signifying to increment the multimedia index. When the input does signify that the multimedia index is to be incremented, in step 935 a trigger comprising a ‘next multimedia index’ command is created and in step 970 the created trigger is sent to a computing platform 110. When the input does not signify that the multimedia index is to be incremented, in step 940 a determination is made as to the input signifying to stop the multimedia presentation. When the input does signify to stop the multimedia presentation, in step 945 a trigger comprising a ‘stop’ command is created and in step 970 the created trigger is sent to a computing platform 110. When the input does not signify to stop the multimedia presentation, in step 950 a determination is made as to the input signifying to start a multimedia sequence. When the input does signify to start a multimedia sequence, in step 955 a trigger comprising a ‘start multimedia sequence’ command is created and in step 970 the created trigger is sent to a computing platform 110. When the input does not signify to start a multimedia sequence, in step 960 a determination is made as to the input signifying to start a multimedia presentation. When the input does signify to start a multimedia presentation, in step 965 a trigger comprising a ‘start’ command is created and in step 970 the created trigger is sent to a computing platform 110. When the input does not signify to start a multimedia presentation, execution returns to step 910.

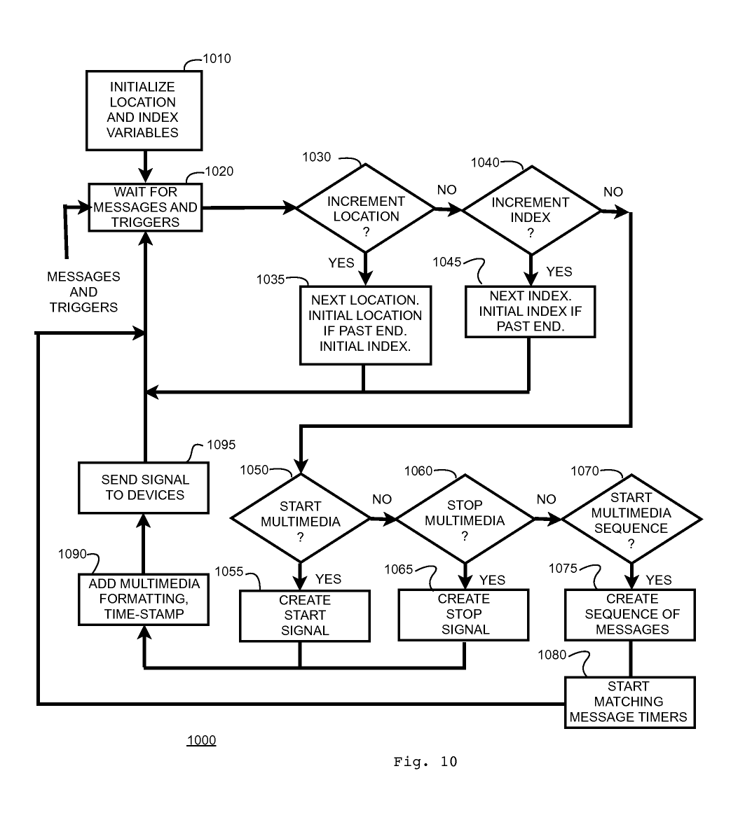

FIG. 10 is a flow diagram of exemplary steps 1000 for sending signaling from a computing platform 110. The steps 1000 can be implemented, for example, by a signaling module 115 in conjunction with a computing platform 110. In step 1010 an initial multimedia content location and an initial multimedia content index are initialized. The multimedia content location represents a series of one or more folders where multimedia content 230 is located alternatively on each multimedia device 250 when downloaded, or on a media storage repository 220 when the content is streamed. The folders can be accessed one after another in a sequence that can be repeated. The multimedia content index indicates a particular multimedia content 230 instance at the multimedia content location. A plurality of multimedia content indices at the multimedia content location can be accessed in sequence, and the index can be reset for each multimedia content location accessed. The number and the order of the multimedia content locations, the number and the order of the multimedia indices, time lapses (e.g. durations or delays) between multimedia content presentations, and a list of multimedia devices 250 to be signaled can be entered in advance by an operator and stored in the signaling module 115. In step 1020 the signaling module 115 waits for the receipt of an internal message, such as a timer expiry message, or a trigger from triggering module 130. Upon receipt of a message or trigger, in step 1030, a determination is made as to whether a ‘next multimedia location’ (i.e. increment location) trigger was received. When the trigger is an increment location, in step 1035 the multimedia content location is incremented to the next folder in the multimedia content location sequence. When this results in incrementing past a last multimedia content location, the first multimedia content location is used and the multimedia content index is set to a first multimedia content index. When the trigger is not an increment location, in step 1040 a determination as to whether a ‘next multimedia index’ (i.e. increment index) trigger was received. When the trigger is an increment index, in step 1045 the multimedia content index is incremented to the next index in the multimedia content location (i.e. folder). When this results in incrementing past a last multimedia content index, the index is set to a first multimedia content index in the multimedia content location.

When the trigger is not an increment index, in step 1050 a determination is made as to whether the received trigger indicates to start a multimedia presentation (i.e. a start trigger). When the trigger is a start trigger, in step 1055 a MMCM containing a start command, the current multimedia content location and the current multimedia content index is created (i.e. a start signal). When the trigger is not a start trigger, in step 1060 a determination is made as to whether the trigger indicates to stop the multimedia presentation (i.e. stop trigger). When the trigger is a stop trigger, in step 1065 a MMCM containing a stop command, the current multimedia content location and the current multimedia content index is created (i.e. a stop signal). After a start signal or a stop signal is created in either of the steps 1055 or 1065, in step 1090 the fields of the MMCM are formatted in accordance with the description above with reference to FIG. 4 including the addition of time-stamps. In step 1095, the signal (i.e. the MMCM) is send to the multimedia devices 250.

When the trigger is not a stop trigger, in step 1070 a determination is made as to whether the trigger indicates to start a multimedia sequence (i.e. a start sequence trigger). When the trigger is a start sequence trigger, is step 1075 a series of start, stop, increment location and increment index internal messages are created based on a sequence configured in advance by the operator. In step 1080, a plurality of corresponding (i.e. synchronized) system timers are started based on the relative timing between multimedia content items in the sequence. The messages are formatted as triggers in accordance with the description above with reference to FIG. 7 and each message (i.e. trigger) is processed at step 1020 when the corresponding system timer expires.

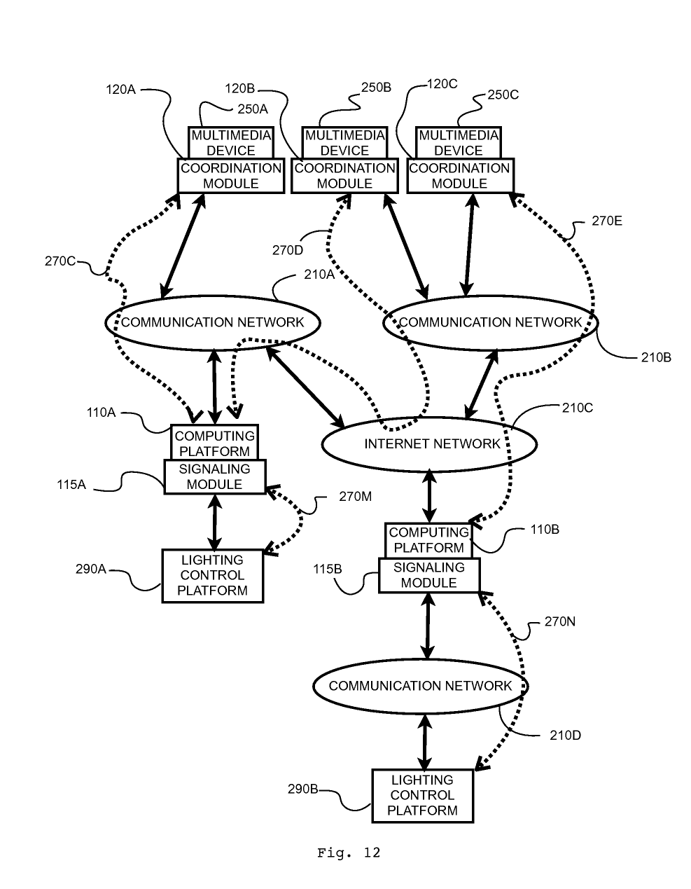

FIG. 12 is a schematic representation of signaling from lighting control platforms 290A-B to a computing platforms 110A-B. The scenario illustrated is similar to that of FIG. 2 with the addition of the lighting control platforms 290A-B and communications network 210D. The lighting control platform 290A can send trigger signals to computing platform 110A via signaling module 115A along path 270M. The lighting control platform 290B can send trigger signals to computing platform 110B via signaling module 115B through communication network 210D along path 270N. The signaling sent by the lighting control platforms 290A-B comprise triggers to start, stop or change multimedia content being presented. The lighting control platforms 290A-B can include support for protocols such as, for example, United States Institute for Theatre Technology, Inc. (USITT) DMX-512 control protocol. A trigger message sent from either of the lighting control platforms 290A-B results in the presentation of multimedia content 230 on the plurality of multimedia devices being coordinated with the operation of other presentation devices (e.g. theatrical lighting, projectors and other similar devices) by the lighting control platform 290A-B. In an alternative embodiment, more than one lighting control platform 290 is used, signaling responsibilities can be assigned to a first lighting control platform 290, with the remaining lighting control platforms 290 available in case of a failure of the first lighting control platform 290.

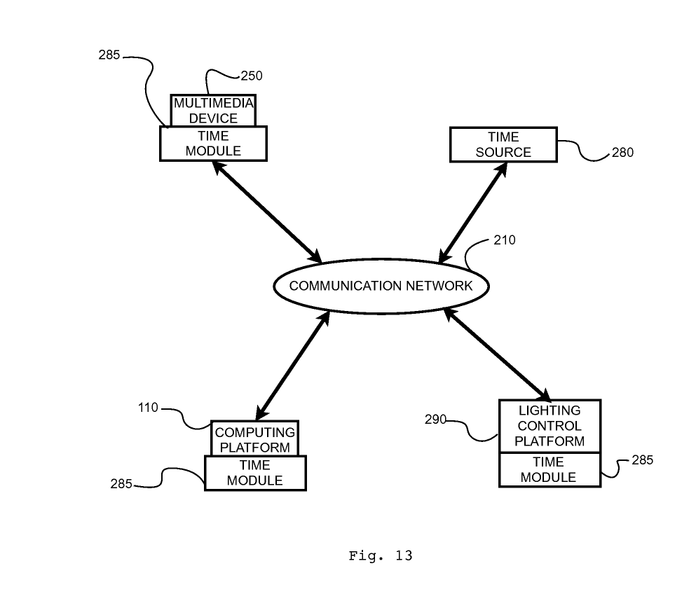

FIG. 13 is a schematic representation of time synchronization. Each of multimedia device 250, computing platform 110 and lighting control platform 290 have an associated time module 285. Each of the time modules can connect, communication network 210, to a time source 280 to obtain a time reference to synchronize with using a well-known time synchronization mechanism such as, for example, IETF RFC 1305 Network Time Protocol (NTP). Each of multimedia device 250, computing platform 110 and lighting control platform 290 can change its local system time to the time reference, or alternatively use an offset from the time reference.

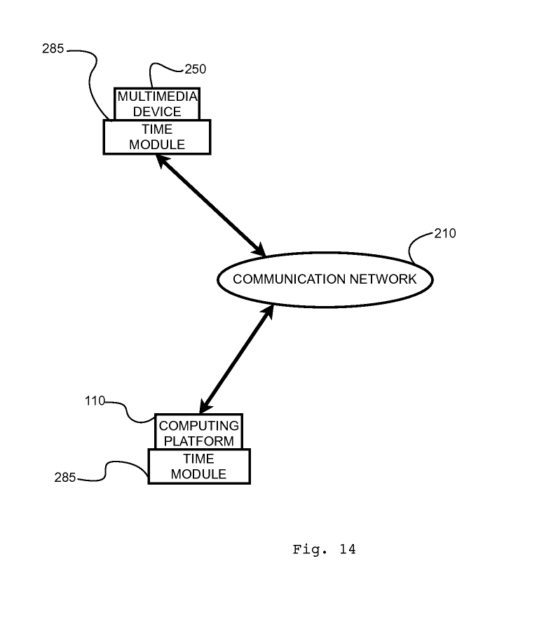

FIG. 14 is a schematic representation of an alternative method of time synchronization. Each of multimedia device 250 and computing platform 110 have an associated time module 285. The time module 285 associated with multimedia device 250 can connect, via the communications network 210, with the time module 285 associated with computing platform 110 to obtain a time reference derived from the system time of the computing platform 110 using a well-known mechanism such as, for example, NTP.

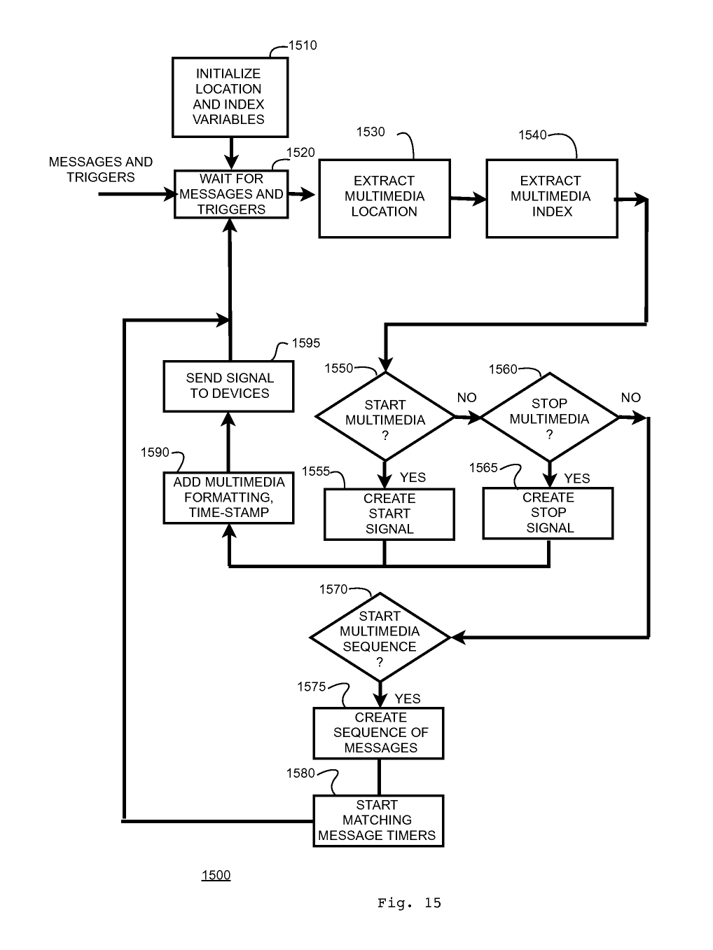

FIG. 15 is a flow diagram of steps 1500 for sending signaling from a computing platform 110 responsive to input from a lighting control platform 290. The steps 1500 can be implemented, for example, by a signaling module 115 in conjunction with a computing platform 110. In step 1510 an initial multimedia content location and an initial multimedia content index are initialized. The multimedia content location represents a series of one or more folders where multimedia content 230 is located alternatively on each multimedia device 250 when downloaded, or on a media storage repository 220 when the content is streamed. The folders can be accessed one after another in a sequence that can be repeated. The multimedia content index indicates a particular multimedia content 230 instance at the multimedia content location. A plurality of multimedia content indices at the multimedia content location can be accessed in sequence, and the index can be reset for each multimedia content location accessed. The number and the order of the multimedia content locations, the number and the order of the multimedia indices, time lapses (e.g. durations or delays) between multimedia content presentations, and a list of multimedia devices 250 to be signaled can be entered in advance by an operator and stored in the signaling module 115. In step 1520 the signaling module 115 waits for the receipt of an internal message, such as a timer expiry message, or a trigger from lighting control platform 290. Upon receipt of a message or trigger, in step 1530, a multimedia content location is extracted from the trigger or message. In step 1040 a multimedia content location is extracted from the trigger or message.

In step 1550 a determination is made as to whether the received trigger indicates to start a multimedia presentation (i.e. a start trigger). When the trigger is a start trigger, in step 1555 a MMCM containing a start command, the current multimedia content location and the current multimedia content index is created (i.e. a start signal). When the trigger is not a start trigger, in step 1560 a determination is made as to whether the trigger indicates to stop the multimedia presentation (i.e. stop trigger). When the trigger is a stop trigger, in step 1565 a MMCM containing a stop command, the current multimedia content location and the current multimedia content index is created (i.e. a stop signal). After a start signal or a stop signal is created in either of the steps 1555 or 1565, in step 1590 the fields of the MMCM are formatted in accordance with the description above with reference to FIG. 4 including the addition of time-stamps. In step 1595, the signal (i.e. the MMCM) is send to the multimedia devices 250.

When the trigger is not a stop trigger, in step 1570 a determination is made as to whether the trigger indicates to start a multimedia sequence (i.e. a start sequence trigger). When the trigger is a start sequence trigger, is step 1575 a series of start, stop, increment location and increment index internal messages are created based on a sequence configured in advance by the operator. In step 1580, a plurality of corresponding (i.e. synchronized) system timers are started based on the relative timing between multimedia content items in the sequence. The messages are formatted as triggers in accordance with the description above with reference to FIG. 7 and each message (i.e. trigger) is processed at step 1520 when the corresponding system timer expires.

The method according to the present invention can be implemented by computer executable program instructions stored on a computer-readable storage medium.

In accordance with the present invention, multimedia content 230 is experienced (e.g. viewed) by participants (i.e. users) using their multimedia devices 250 such as, for example, cellular phone, Wi-Fi enabled iPod®, or Ethernet connected laptop computer. Among other benefits, all participants are provided a very good view of the multimedia. Also presenting multimedia on multiple multimedia devices 250 is in itself a unique form of multimedia presentation, especially as the present invention coordinates multimedia amongst devices 250 and allows multimedia devices 250 to be components of multimedia patterns, sequences and more.

That the invention does flexibly use different network communication 110 mechanisms, and does work with multiple types of multimedia devices 250 means that for the lecture example given in the Background of the Invention section above, in addition to those lecture participants in the same room as the lecturer, lecture participants can be also at a site other than the lecture room. The remote participants watch the lecture over television or streaming video at a separate physical location, and with the benefit of the invention watch the multimedia content 230 on their multimedia device 250 (e.g. personal computer or cellular phone) in the same manner as those physically attending the lecture.

From the same lecture example, the ability of the invention to control the display content on one or more multimedia devices 250 means that some participants can receive different multimedia content 230 than other participants, for example advanced students might receive enhanced multimedia content 230. Similar to this, the ability to show different multimedia content 230 based on multimedia device 250 physical location lets participants receive custom multimedia content 230 based on whether they are located inside or remote to the presentation room, or even based on where they are within the presentation room.

In the lecture example, the lecturer triggers the manual or automated signaling to the multimedia devices 250 from a computing platform 110 or from a variety of multimedia devices 250, for example the lecturer's cell phone or laptop computer. Using a communication network 110 to trigger the signaling permits the computing platform 110 performing the signaling to be contained in the lecture room, or alternatively the computing platform 100 may be elsewhere. Alternatively using a multimedia device 250 to trigger the control of the multimedia content 230 lets the lecturer see the content exactly as the lecture participants are receiving it.

The ability of the invention to use a lighting or multimedia control platform 290 as a control mechanism means that the multimedia presented on the multimedia devices 250 can be coordinated with other forms of displays such as concert lighting systems, video screens, and similar display device controllable by the lighting control platform 290.

The ability of the present invention to manually trigger or control what multimedia content 230 is presented and when to start and stop the presentation on the multimedia devices 250 permits human control of all multimedia device 250 presentations.

The present invention's automated timed sequence of signaling to multimedia devices 250 and resulting automated timed in sequence presentation of the multimedia content 230 permits the multimedia content 230 to be shown in a manner not possible using manual control of the presentation, including, for example, coordinated distributed multimedia patterns and sequences that change quickly. Similarly instead of a computing platform sending the signaling information in a timed sequence, further flexibility is provided by including timing information in the signaling such that multimedia devices themselves execute the multimedia display changes at described times.

That the present invention can use any of a plurality of alternative means to coordinate time of day between the lighting or multimedia control platform, computing platform and devices means that the invention can work in a variety of communication network environments.

The ability of the present invention to control the display content on one or more multimedia devices means that some participants can receive different multimedia content than other participants, for example based on the type and capabilities of a particular multimedia device. For example a cellular phone display capability can be different than that of an iPod®, and can require different multimedia content. Similar to this, the ability to show different multimedia content based on multimedia device physical location creates larger patterns or sequences of multimedia, with individual multimedia devices displaying a component of the overall multimedia display. For example individual multimedia devices can receive custom multimedia content based on whether they are located inside or remote to the presentation room, or based on where they are within the presentation room. The user of a multimedia device can input data to the device to affect what multimedia is displayed on the device, for example providing data such as seating location so that the multimedia displayed on the device can be a component of a larger multimedia display, or providing data such as which sports team the participant supports so that multimedia related to that sports team is presented on the user's multimedia device.

The ability of the invention to determine geographic location by multiple methods means that the invention can work both inside buildings where methods such as GPS may not be available, and outdoors where GPS may be available.

It will be apparent to one skilled in the art that numerous modifications and departures from the specific embodiments described herein may be made without departing from the spirit and scope of the present invention.

1. A method for controlling the presentation of multimedia content on a plurality of multimedia devices comprising the steps of:
establishing a list of the plurality of multimedia devices;
providing each of the multimedia devices with one or more items of multimedia content;
responsive to receiving a trigger message, creating and sending, to one or more of the multimedia devices on the list, a multimedia control message (MMCM);
responsive to fields contained in the MMCM, each multimedia device initiating an action including one of: starting presentation, stopping presentation, and presenting a next item of multimedia content; and
repeating, for subsequently received trigger messages, the steps of creating and sending a MMCM, and of initiating an action;
wherein the presentation of multimedia items on the plurality of multimedia devices creates a form of multimedia presentation unto itself.

2. The method of claim 1, wherein one or more multimedia content items, each having an associated content index, are organized into one or more content locations;

3. The method of claim 2, wherein the trigger message can indicate one of: switch to a next content location, switch to a next content index, start a presentation, start a presentation sequence, and stop a presentation.

4. The method of claim 1, wherein each multimedia device is added to the list responsive to one of: the multimedia device registering for participation in a presentation via a communication protocol, a user of the multimedia device requesting inclusion of the multimedia device, and an operator entering one or more multimedia devices.

5. The method of claim 1, wherein each multimedia device can be removed from the list responsive to a user of the multimedia device requesting exclusion of the multimedia device.

6. The method of claim 1, wherein in the step of initiating an action, the action is initiated at a time that is responsive to a command time-stamp contained in the MMCM.

7. The method of claim 6, further comprising the step of:
synchronizing the time for initiating an action on the multimedia device with a time reference from which the command time-stamp was derived.

8. The method of claim 4, wherein registration of a multimedia device for participation in a presentation includes providing physical location information for the multimedia device, and the step of creating and sending an MMCM is further responsive to the physical location information provided by the multimedia device.

9. The method of claim 1, wherein the one or more items of multimedia content are provided to each multimedia device by one of: downloading the items in advance of the presentation, and streaming of the items in real-time during the presentation.

10. The method of claim 1, further comprising the step of:
forwarding the received MMCM from the multimedia device to other multimedia devices responsive to a list of other multimedia devices on the multimedia device.

11. The method of claim 1, wherein the trigger message is sent from any of: a user input interface, a multimedia device, and a lighting control platform.

12. The method of claim 11, wherein the trigger message sent from lighting control platform results in the presentation of multimedia content on the plurality of multimedia devices being coordinated with the operation of other display devices by the lighting control platform.

13. A system for controlling the presentation of multimedia content on a plurality of multimedia devices comprising:
a computing platform for:
establishing a list of the plurality of multimedia devices;
responsive to receiving a trigger message, creating a multimedia control message (MMCM); and
creating further MMCM for each subsequently received trigger message;
a signaling module for sending the MMCM to one or more of the multimedia devices on the list; and
a plurality of coordination modules, each associated with one of the multimedia devices, for:
making available to the multimedia device one or more items of multimedia content; and
responsive to fields contained in the MMCM, causing the multimedia device to initiate an action including one of: starting presentation, stopping presentation, and presenting a next item of multimedia content; and
causing the multimedia device to initiate a further action for each subsequently received MMCM;
wherein the presentation of multimedia items on the plurality of multimedia devices creates a form of multimedia presentation unto itself.

14. The system of claim 13, wherein one or more multimedia content items, each having an associated content index, are organized into one or more content locations;

15. The system of claim 14, wherein the trigger message can indicate one of: switch to a next content location, switch to a next content index, start a presentation, start a presentation sequence, and stop a presentation.

16. The system of claim 13, wherein each multimedia device is added to the list responsive to one of: the multimedia device registering for participation in a presentation via a communication protocol supported by the computing platform, a user of the multimedia device sending a request forinclusion of the multimedia device to the computing platform, and an operator entering one or more multimedia devices on the computing platform.

17. The system of claim 13, wherein each multimedia device can be removed from the list responsive to a user of the multimedia device sending a request for exclusion of the multimedia device to the computing platform.

18. The system of claim 13, wherein in the action is initiated, by the coordination module, at a time that is responsive to a command time-stamp contained in the MMCM.

19. The system of claim 18, the coordination module further for:
synchronizing the time for initiating an action on the multimedia device with a time reference from which the command time-stamp was derived.

20. The system of claim 16, wherein registration of a multimedia device for participation in a presentation includes providing physical location information for the multimedia device, and the creating of the MMCM is further responsive to the physical location information provided by the multimedia device.

21. The system of claim 13, wherein the one or more items of multimedia content are made available to each multimedia device by one of: downloading the items in advance of the presentation, and streaming of the items in real-time during the presentation.

22. The system of claim 13, the coordination module further for:
forwarding the received MMCM from the multimedia device to other multimedia devices responsive to a list of other multimedia devices on the multimedia device.

23. The system of claim 13, further comprising a trigger module for sending the trigger message responsive to input from any of: a user input interface, a multimedia device, and a lighting control platform.

24. The system of claim 23, wherein the trigger message input from lighting control platform results in the presentation of multimedia content on the plurality of multimedia devices being coordinated with the operation of other display devices by the lighting control platform.

25. The system of claim 23, further comprising the user input interface for receiving input from a user and forwarding the input to the trigger module.

26. The system of claim 25, wherein the user input interface is associated with one of: the computing platform, another computing platform, and a multimedia device
